(19) United States
(12) Patent Application Publication
(10) Pub. No.: US 2014/0303941 A1
(43) Pub. Date: Oct. 9, 2014

(54) METHOD FOR GENERATING MODELING FILES OF AN INTEGRATED CIRCUIT DESIGN FLOW, CORRESPONDING COMPUTER PROGRAM AND SYSTEM

(71) Applicant: COMMISSARIAT A L'ENERGIE ATOMIQUE ET AUX ENE ALT, Paris (FR)

(72) Inventor: Gerald CIBRARIO, La Buisse (FR)

(73) Assignee: COMMISSARIAT A L'ENERGIE ATOMIQUE ET AUX ENE ALT, Paris (FR)

(21) Appl. No.: 14/225,834

(22) Filed: Mar. 26, 2014

(30) Foreign Application Priority Data
Mar. 26, 2013 (FR) 13 52721

(51) Int. Cl. G06F 17/50

(52) U.S. Cl. CPC G06F 17/5081
USPC 703/1

(57) ABSTRACT

This method for generating modeling files (60) of a design flow of an integrated circuit with a plurality of layers interconnected together comprises the following steps: providing (100, 102) reference files (54) modeling a reference design flow including a predefined set (50, 52) of three-dimensional connection devices and reference design rules; providing (104) a design rule manual (58) relating to a sought integrated circuit design flow; generating (106) modeling files (60) of the sought design flow based on the reference files (54) and the design rule manual (58) provided.

The sought three-dimensional connection devices (56) all being chosen from the reference three-dimensional connection devices, the step (106) for generating the modeling files (60) of the sought design flow comprises filtering of the reference files (54) by deleting any data relating to non-selected three-dimensional connection devices and by specifying the reference design rules (50) using the design rule manual (58) provided.

The present invention relates to a method for generating modeling files of an integrated circuit design flow, for an integrated circuit with a plurality of layers interconnected together by three-dimensional connection devices. It also relates to a corresponding computer program and system.

As a general rule, using a given three-dimensional technology, using sought components and layers in the integrated circuit to be designed and using a design rule manual, the generation, using dedicated software, of the modeling files of the sought integrated circuit design flow is known.

The term “modeling files of an integrated circuit design flow” denotes the set of files generally referred to as PDK (Process Design Kit) and comprising:
software libraries of standard functional cells,
the design rules of the integrated circuit,
specific integrated circuit component simulation models, and
layout information.

The term “design rules” denotes a set of recommended parameters associated with layout constraints of the components and layers used for integrated circuit design. These design rules are subject to DRC (Design Rule Checking) checks in the design flow using suitable known software. It relates generally at least to values of widths (i.e. minimum component widths in the design), spacing (i.e. minimum spacing between components in the design) or overlap of a component with another between two layers (i.e. minimum overlap margin of one component with another in the design). They are compiled in one or a plurality of description files, the whole being referred to as a “Design Rule Manual” (DRM), provided by a specialist, working upstream from the integrated circuit designer, to check the correct layout of the masks to be created. This specialist is generally referred to as a technologist. The design rules are specific to a given manufacturing technology and act as a set of restrictions in terms of geometry and connectivity ensuring sufficient margins of error accounting for manufacturing variabilities of the various components of the printed circuit.

In this integrated circuit design scheme, whenever a new integrated circuit is to be designed, the technologist needs to provide a new DRM specific for the new circuit and, using this new DRM, a new PDK can be created. It would appear to be advantageous, for time-saving reasons, to be able to use predefined PDKs in order to construct new ones based on new DRMs provided by the technologist.

The invention thus applies more particularly to the generation of modeling files of a sought design flow, this design flow being that of an integrated circuit with a plurality of layers interconnected together by sought three-dimensional connection devices, comprising the following steps:
providing reference files modeling a reference design flow including a predefined set of three-dimensional connection devices and reference design rules,
providing a design rule manual relating to the sought design flow,
generating modeling files of the sought design flow based on the reference files and the design rule manual provided.

The predefined PDK is thus considered as a reference PDK from which the new PDK is constructed on the basis of a new DRM. However, this operation is not simple. Indeed, as technology is subject to change, the reference PDK soon becomes obsolete and it is then necessary to add updates manually. Furthermore, according to the approach generally envisaged, a minimalist reference PDK is adopted, a new PDK being obtained on the basis of a new DRM and using the reference PDK by further additions relative to the specificities of the new PDK sought.

This involves adding, on a case-by-case basis, additional functions in the form of add-ons. The time saved and simplification sought, resulting from the use of a minimalist reference PDK for the generation of a new PDK, actually remain limited or even debatable. This approach is thus not satisfactory.

It may thus be sought to provide a method for generating modeling files of an integrated design flow suitable for overcoming at least some of the problems and constraints mentioned above.

It is thus proposed a method for generating modeling files of a sought design flow, this design flow being that of an integrated circuit with a plurality of layers interconnected together by sought three-dimensional connection devices, comprising the following steps:
providing reference files modeling a reference design flow including a predefined set of three-dimensional connection devices and reference design rules,
providing a design rule manual relating to the sought design flow,
generating modeling files of the sought design flow based on the reference files and the design rule manual provided,
   wherein, the sought three-dimensional connection devices all being chosen from the three-dimensional connection devices of the reference design flow, the step for generating the modeling files of the sought design flow comprises filtering of the reference files by deleting any data relating to non-selected three-dimensional connection devices and by specifying the reference design rules using the design rule manual provided.

In this way, the proposed method makes it possible not to have to use add-ons. It also has further advantages. Firstly, it makes it possible, using a given technology, particularly in respect of three-dimensional connection devices, to construct a complete reference PDK and propose adapting this complete reference

PDK to the specific requirements expressed in a client DRM merely by filtering, i.e. by merely selecting the data relating to the three-dimensional connection devices selected by the client while deleting the other data and by specifying predefined design rules according to the client's requirements. The owner of the technology in question thus retains control thereof while being to share same. Secondly, the adaptation of the reference PDK by filtering as defined above is much easier to carry out than an adaptation using add-ons.

Optionally, the reference three-dimensional connection devices comprise at least one of the elements from the set consisting of micro-bumps, landing micro-bumps, front side UBMs, contact blocks, TSV vias, back side UBMs, pillars and landing pillars.

Also optionally, the provision of reference files modeling a reference design flow comprises the compilation of a reference design rule manual relating to the reference design flow based on a reference technological proposal comprising all the reference three-dimensional connection devices and the generation, based on this reference design rule manual, of a reference three-dimensional connection device description file.

Also optionally, the design rules of the reference design rule manual are described with at least minimum, nominal and maximum values for each layer of the reference technological proposal.

Also optionally, the reference files modeling the reference design flow are compiled using the reference design rule manual based on nominal values, excluding minimum and maximum values.

Also optionally, the step for generating modeling files of the sought design flow comprises the six following phases:
checking the syntax of the reference files modeling the reference design flow,
saving description data relating to the sought and selected three-dimensional connection devices,
interpreting the design rules relating to the sought design flow,
building the modeling files of the sought design flow by filtering the reference files modeling the reference design flow,
compiling a technological file and creating a software library from the modeling files of the sought design flow, and
constructing a tree structure of the modeling files of the sought design flow.

A computer program downloadable from a communication network and/or saved on a computer-readable medium and/or executable by a processor, comprising instructions for executing steps of a method for generating modeling files of an integrated circuit design flow according to the invention, when said program is executed on a computer, is further proposed.

A system for generating modeling files of a sought design flow is further proposed, this design flow being that of an integrated circuit with a plurality of layers interconnected together by sought three-dimensional connection devices, comprising:
means for storing reference files modeling a reference design flow including a predefined set of three-dimensional connection devices and reference design rules,
means for storing a design rule manual relating to the sought design flow including sought three-dimensional connection devices,
a processor having access to the means for storing and generating modeling files of the sought design flow using the reference files and the design rule manual provided,
   wherein, the sought three-dimensional connection devices all being selected from the three-dimensional connection devices of the reference design flow, the system comprises means for filtering the reference files by deleting any data relating to unselected three-dimensional connection devices and by specifying the reference design rules using the design rule manual provided, these filtering means being executable by the processor for generating modeling files of the sought design flow.

Optionally, a system for generating modeling files of an integrated circuit design flow according to the invention may comprise an input interface, executable by the processor, for supplying, by a user, at least part of the design rules relating to the sought design flow including the sought three-dimensional connection devices, this input interface comprising:
a field for selecting sought three-dimensional connection devices in the predefined set of three-dimensional connection devices of the reference design flow,
a field for inputting design rule values relating to the selected three-dimensional connection devices.

Also optionally, the input interface may be configured for inputting information from the design rule manual relating to the sought design flow and completing same.

The invention will be understood more clearly using the following description, given merely as an example with reference to the appended drawings wherein:

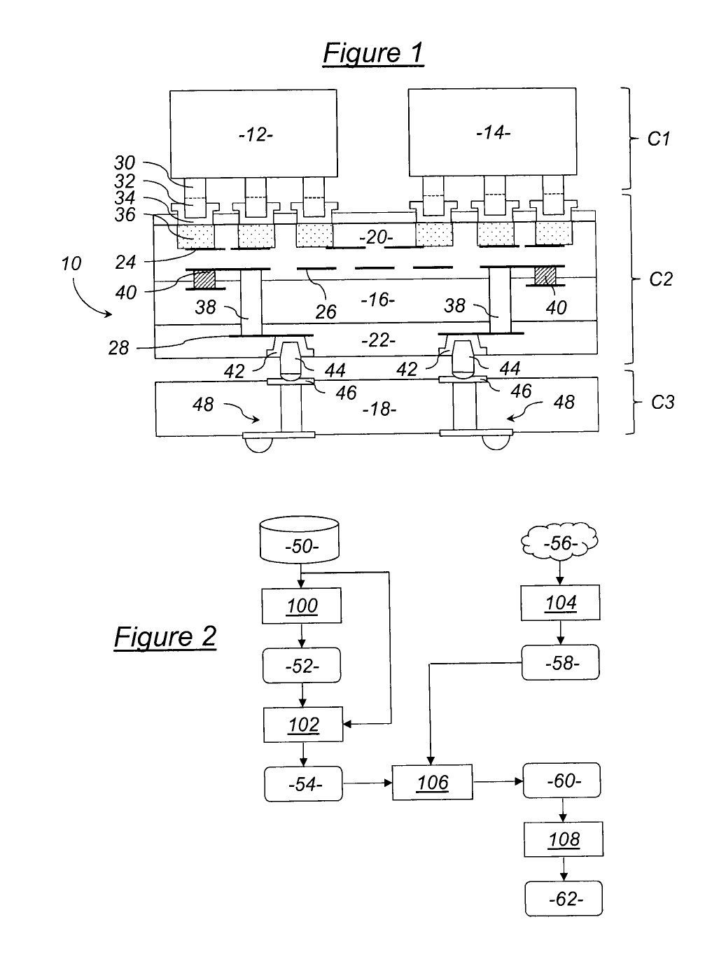

FIG. 1 schematically represents the general structure of an example of a reference technological proposal in respect of three-dimensional connection devices,

FIG. 2 illustrates the successive steps of a method for generating modeling files of an integrated circuit design flow, according to one embodiment of the invention, executed on the basis of the technological proposal in FIG. 1, and

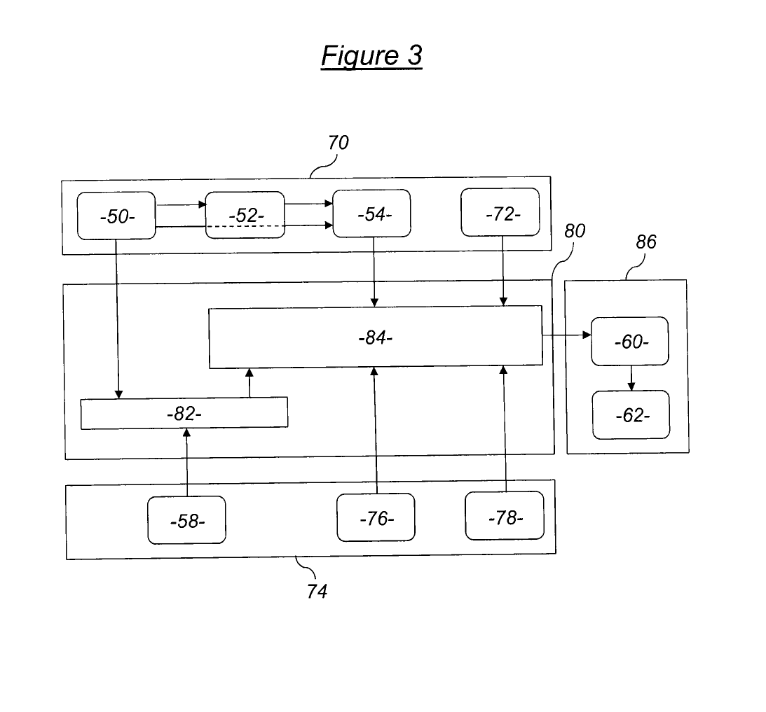

FIG. 3 schematically represents the general structure of a computer system for implementing the method in FIG. 2.

The three-layer integrated circuit 10 represented schematically in FIG. 1 comprises, by way of a merely illustrative and non-limiting example, two upper silicon electronic chips 12 and 14 on a first layer C1, an interposed electronic chip 16 also made of silicon on a second layer C2 and a substrate 18 on a third layer C3. The second layer C2 also comprises, above and below the interposed electronic chip 16, two isolating layers 20 and 22 wherein metal tracks 24, 26 (for the upper isolating layer 20) and 28 (for the lower isolating layer 22) are printed. This integrated circuit 10 represents a reference technological proposal relating to an integrated circuit with a plurality of layers interconnected together by reference three-dimensional connection devices.

In particular, between the first and second layers C1 and C2, reference three-dimensional connections devices are proposed. More specifically, between the upper electronic chip 12 of the layer C1 and the metal track 24 of the upper isolating layer 20 of the layer C2, three connection “micro-bumps” 30 are extended respectively by lower portions 32 of connection bumps, generally referred to as “landing micro-bumps”, in turn arranged respectively on three front metal-coated parts 34 for receiving connection bumps, generally referred to as “front side UBMs” (UBM for “Under Bump Metallurgy”). These three metal-coated parts 34 for receiving connection bumps are integrated in the upper part of the upper isolating layer 20 and arranged respectively on three contact blocks 36 for connecting to the metal track 24.

Between the upper electronic chip 14 of the layer C1 and the metal track 24 of the upper isolating layer 20 of the layer C2, the same three-dimensional connection devices are proposed.

Also in particular, inside the second layer C2, between the upper isolating layer 20 and the lower isolating layer 22, reference three-dimensional connection devices are proposed. More specifically, two TSV type through silicon vias 38 are arranged between the metal track 26 of the upper isolating layer 20 and the metal track 28 of the lower isolating layer 22. It should further be noted that two transistors 40 are integrated by way of example in the interposed electronic chip 16 and connected to the metal track 26.

Also in particular, between the second and third layers C2 and C3, reference three-dimensional connection devices are proposed. More specifically, between the metal track 28 of the lower isolating layer 22 of the layer C2 and the substrate 18, two rear metal-coated parts 42 for receiving connection bumps, generally referred to as “back side UBMs”, are integrated in the lower isolating layer 22 and connected to the metal track 28. Against these two rear receiving metal-coat parts 42 are respectively arranged, between the second and third layers C2 and C3, two pillars 44, usually adopting the form of connection beads. These two pillars 44 rest respectively on two parts 46 for receiving pillars, generally referred to as “landing pillars”, integrated in the upper part of the substrate 18. Finally, through the thickness of the substrate 18, additional connection devices, bearing the general reference 48, are suitable for connecting two parts 46 for receiving pillars to wires situated on the lower face of the substrate 18.

In this way, a predefined set of reference three-dimensional connection devices is formed. In the example illustrated by FIG. 1, it particularly comprises micro-bumps 30, landing micro bumps 32, front side UBMs 34, contact blocks 36, TSV vias 38, back side UBMs 42, pillars 44 and landing pillars 46. In the sequence of steps illustrated in FIG. 2, it is defined by at least one file stored in memory, this file bearing the reference 52.

During a step 100 of the method for generating modeling files of a design flow illustrated in FIG. 2, the file 52 is generated using a pre-existing reference design rule manual, or reference DRM 50, associated with the integrated circuit 10 and describing the design rules thereof completely.

In practice, the description file 52 of the reference three-dimensional connection devices should contain the list of all the three-dimensional connection devices which are previously identified in the reference DRM 50. Each reference three-dimensional connection device description may for example contain the following data:
the name thereof,
the list of the constituent layers thereof,
the name of the PCell (Parameterized Cell) file thereof,
the name of the CDF (Component Description Format) file thereof,
the name of the cell created for the layout, i.e. for the layout information.

The syntax for each reference three-dimensional connection device is for example as follows (example given for a TSV via):
#Device TSV
layersName b1tsv, b1rdl1, f1lne0
filePcellName pc_TSV.il
fileCdfName pc_TSV.cdf
cellName PC_TSV

The construction of the reference DRM 50 and the generation 100 of the file 52 are based on well-known methods and will not be detailed. However, it should be noted that advantageously, unlike a conventional DRM, wherein for each layer, design rules are described with minimum values, the reference DRM 50 has for each design rule a range of values involving more or less risk, such as minimum, nominal, maximum values, etc. For example, for the layer b1tsv of a TSV via 38, a design rule table may be defined as follows:

| Rule | Min | Rran | Sran | Nom | Imp | Max |
|---|---|---|---|---|---|---|
| b1tsv width | 30 | 30-40 | 40-100 | 60 | — | 100 |
| b1tsv space | 30 | 30-40 | >40 | 60 | — | — |
| b1tsv enclosure/f1lne0 | 3 | 3-5 | >5 | 10 | — | — |
| b1tsv shape | 16 | — | — | 32 | — | 64 |

In this design rule table, the “Min” column relates to the minimum values, the “Nom” column relates to the nominal values, the “Max” column relates to the maximum values, the “Imp” column relates to imposed values and the “Rran” and “Sran” columns relate to value ranges with predefined risks.

During a step 102, a set of reference files modeling a complete reference design flow for the reference technological proposal in FIG. 1, or reference PDK 54, is constructed from the reference DRM 50 and the file 52. It should be noted that the reference PDK 54 contains all the three-dimensional connection devices of the reference DRM 50 described in the file 52 but only reproduces the nominal values of the design rules thereof for DRC checking.

In order to retain some technological flexibility, a plurality of files contained in the reference PDK 54 may be personalized to remain flexible to all requests. This is particularly the case of the DRC checking data file which, as mentioned above, reproduces the nominal values of the design rules of the reference DRM 50. Given that these rules are required to be modified according to the requirements of a sought design flow, to determine with which three-dimensional connection device a rule is associated, the name of the device in question is specified as an argument. For example:
set b1rdl1_width_routing 60 ;#TSV

This instruction makes it possible to select the rule b1rdl1_width_routing relating to the TSV three-dimensional connection device and adjust same to a final value.

The steps 100 and 102 only need to be repeated when the reference technological proposal is modified in the reference DRM 50 so as to adapt the file 52 and the reference PDK 54 to these modifications.

Independently of the execution of these steps, a set of connection devices sought by a user is selected from the devices of the predefined set of reference three-dimensional connection devices for the design of an integrated circuit with a plurality of layers further comprising other sought functional elements. This set of sought connection devices is selected for example during meetings. The selection made is illustrated in FIG. 2 by the reference 56. Using the selected connection devices, further functional elements sought for the integrated circuit to be designed and the reference PDK 54, the method illustrated in FIG. 2 aims to provide modeling files of a design flow relating to the integrated circuit to be designed.

In this way, during a step 104, a design rule manual relating to the sought design flow, or client DRM 58, is constructed based on the selection made 56. The construction 104 of the client DRM 58 is based, like that of the reference DRM 50, on a well-known method which will not be detailed. However, it should be noted that, unlike the reference DRM 50, the client DRM 58 is completely conventional, such that, for each layer, the design rules are described with minimum values to be applied.

During a step 106 for generating a set of modeling files of the sought design flow, or client PDK 60, using the reference PDK 54 and the client DRM 58, the reference PDK 54 is filtered by deleting any data relating to non-selected three-dimensional connection devices and by specifying the reference design rules using the client DRM 58. This filtering results in a reduced PDK acting as the client PDK 60.

More specifically, during this step 106, a first phase consists of checking the syntax of some of the various files of the reference PDK 54 such as for example the technological file for layer registration, the template file for design rule checking, etc.

A second phase consists of saving all the data contained in the description files relating to the selected three-dimensional connection devices 56 for constructing parameterized cells firstly (constraint file) and for describing the selected connection devices secondly (3D catalog file).

A third phase consists of interpreting all the design rule values of the client DRM 58 to ensure that all the constraints described in the above-mentioned files (constraint file and 3D catalog file) are complied with. The completion of this phase is well-known to those skilled in the art and will not be detailed.

A fourth phase consists of concretely constructing the files of the client PDK 60 accounting for the selection of the connection devices selected for performing the filtering mentioned above, i.e. deleting any data relating to three-dimensional connection devices not selected in the predefined set 52 and specifying the design rules defined in the reference PDK 54 using those defined in the client DRM 58. All the information compiled at this stage of the method makes it possible in a manner known per se to register the stacking layers in the above-mentioned technological file, construct the parameterized cells and adjust the DRC checking.

A fifth phase consists of compiling the resulting technological file, for example using the Cadence (registered trademark) tool, in order to create an essential component of the client PDK 60, i.e. the technological software library thereof. This technological software library thus enables mask design using the client PDK 60 for the design of the sought integrated circuit.

Finally, a sixth and final phase consists of constructing the very tree structure of the client PDK 60 for the mask design.

A final step 108 consists of actually designing, using the client PDK file 60, a model 62 of the sought integrated circuit.

The method for generating modeling files of an integrated circuit design flow as described above may be implemented using an automated system, particularly a computer system, such as that represented schematically in FIG. 3. This system comprises in a manner known per se at least one processing unit associated conventionally with a memory (for example a RAM memory). The processing unit may for example be used in a computer device such as a conventional computer comprising a processor associated with one or a plurality of memories for storing data files and computer programs. The processing unit may then in turn be considered to consist of a processor associated with a memory for storing instructions executed in the form of computer programs.

As illustrated in FIG. 3, the system for generating modeling files of an integrated circuit design flow may comprise a plurality of optionally independent software platforms.

A first platform 70 is for example assigned for generating and updating the reference PDK 54. It stores for example completely independently the reference DRM 50, the description file 52 and the reference PDK 54. The access thereof may be limited only to the owner of the technological proposal illustrated in FIG. 1 and serve as a basis for validating the tools developed by said owner. It comprises computer program instructions for executing steps 100 and 102.

It may further store an additional technological constraint file 72. Indeed, some of the three-dimensional connection devices of the predefined technological proposal, such as the TSV vias 38 for example, are constructed on a plurality of layers which have to comply with rules in respect of the overlap of components by others between successive layers. However, the design rules defined in the reference DRM 50 may cause errors in parameterized cells during DRC checks. For this reason, a file such as the technological constraint file 72 may be envisaged, to contain all the constraints to be complied with. These constraints should be arranged by connection device. For this, the names of the corresponding design rules are used as key words. For example, the following syntax may be used:
[f1lne0_width]−(2*[b1tsv_enclo_f1lne0])>=[b1tsv_width],
   to indicate that the minimum width of a given layer−2×the overlap in relation to another layer should comply with the minimum width of this other layer.

A second platform 74 is for example assigned for storing constraints or selections defined by the client. Of these constraints, a resistivity constraint file 76 and/or an imprint file 78 of the sought printed circuit may be envisaged. The selections of the client are in turn defined in the client DRM 58, for example also stored in the platform 74.

A third platform 80 is assigned for generating the client PDK 60 from the reference PDK 54 and data provided by the client.

For this purpose, in one possible embodiment of the invention, the platform 80 has a data input interface 82. The information input using this interface 82, relating to the three-dimensional connection devices to be selected by the client from those defined in the reference description file 52 and the specifications to be made to the reference design rules, partially reproduce the information contained in the client DRM 58 and should also make it possible to complete same. More specifically, the interface 82 may comprise three separate sections:
one for inputting the working directories with in particular the directory where the client PDK client 60 is to be stored and the name of this PDK, the working directory for the design and mask management part,
another for selecting the three-dimensional connection devices to be selected in the predefined set of reference connection devices, this selection optionally being input using the selections defined in the client DRM 58,
another for the specific definition of the design rule values required for constructing the parameterized cells and DRC validation.

The platform 80 finally comprises a software generator 84 of the client PDK file 60 from the reference PDK file 54 and the information input using the interface 82. This software generator 84 comprises computer program instructions for executing the six phases of the step 106. A debugging interface may be envisaged to monitor the progress of these various phases.

Finally, a fourth platform 86 is assigned for the design of the integrated circuit model 62 sought by the client. It comprises computer program instructions for executing the step 108.

The system for generating modeling files of an integrated design flow as illustrated in FIG. 3 thus functionally comprises four software platforms optionally in the form of four computer programs or four functions of the same computer program. Indeed, it should be noted that the software platforms 70, 74, 80 and 86 are described as separate, but this distinction is merely functional. They may equally well be grouped together according to any possible combinations into one or a plurality of more or less mutually independent software. The functions thereof may also be at least partially micro-programmed or micro-wired in dedicated integrated circuits. In this way, alternatively, the computer device using the system in FIG. 3 could be replaced by an electronic device consisting only of digital circuits (with no computer program) for performing the same actions.

It clearly appears that a method for generating modeling files of an integrated circuit design flow such as that described above enables a significant reduction in the design time of a client PDK by filtering a complete reference PDK offering all the three-dimensional connection technology available to a client. Furthermore, the reference PDK is reusable for a large number of integrated circuits wherein the constraints may vary according to a large number of client DRMs. The reference PDK is furthermore very simple to use by adding, removing or modifying reference three-dimensional connection devices. Finally, the reference DRM 50 can be kept confidential by the designer thereof. Similarly, the reference devices of the reference PDK 54 which are not selected by the client may be kept confidential.

It should further be noted that the invention is not limited to the embodiments described or mentioned above. Indeed, it will be obvious to those skilled in the art that various modifications may be made to the embodiments described above, in the light of the teaching disclosed herein. In the claims hereinafter, the terms used should not be interpreted as limiting the claims to the embodiments described in the present description, but should be interpreted to include any equivalents intended to be covered by claims due to the wording thereof and which may be envisaged by those skilled in the art by applying their general knowledge to the implementation of the teaching disclosed herein.

1. A method for designing an integrated circuit with a plurality of layers interconnected together by sought three-dimensional connection devices (56), comprising the following steps:
providing (100, 102) reference files (54) modeling a reference design flow including a predefined set (50, 52) of three-dimensional connection devices (30, 32, 34, 36, 38, 42, 44, 46) and reference design rules,
providing (104) a design rule manual (58) relating to a sought integrated circuit design flow,
generating (106) modeling files (60) of the sought design flow based on the reference files (54) and the design rule manual (58) provided,
characterized in that, the sought three-dimensional connection devices (56) all being chosen from the three-dimensional connection devices (30, 32, 34, 36, 38, 42, 44, 46) of the reference design flow, the step (106) for generating the modeling files (60) of the sought design flow comprises filtering of the reference files (54) by deleting any data relating to non-selected three-dimensional connection devices and by specifying the reference design rules (50) using the design rule manual (58) provided,
and in that the method further comprises a step for designing a model (62) of the integrated circuit using the modeling files (60) generated.

2. The method for designing an integrated circuit as claimed in claim 1, wherein the reference three-dimensional connection devices (30, 32, 34, 36, 38, 42, 44, 46) comprise at least one of the elements from the set consisting of micro-bumps (30), landing micro-bumps (32), front side UBMs (34), contact blocks (36), TSV vias (38), back side UBMs (42), pillars (44) and landing pillars (46).

3. The method for designing an integrated circuit as claimed in claim 1, wherein the provision (100, 102) of reference files (54) modeling a reference design flow comprises the compilation of a reference design rule manual (50) relating to the reference design flow based on a reference technological proposal (10) comprising all the reference three-dimensional connection devices (30, 32, 34, 36, 38, 42, 44, 46) and the generation (100), based on this reference design rule manual (50), of a reference three-dimensional connection device description file (52).

4. The method for designing an integrated circuit as claimed in claim 3, wherein the design rules of the reference design rule manual (50) are described with at least minimum, nominal and maximum values for each layer of the reference technological proposal (10).

5. The method for designing an integrated circuit as claimed in claim 4, wherein the reference files (54) modeling the reference design flow are compiled using the reference design rule manual (50) based on nominal values, excluding minimum and maximum values.

6. The method for designing an integrated circuit as claimed in claim 1, wherein the step (106) for generating modeling files (60) of the sought design flow comprises the six following phases:
checking the syntax of the reference files (54) modeling the reference design flow,
saving description data relating to the sought and selected three-dimensional connection devices (56),
interpreting the design rules relating to the sought design flow,
building the modeling files (60) of the sought design flow by filtering the reference files (54) modeling the reference design flow,
compiling a technological file and creating a software library from the modeling files (60) of the sought design flow, and
constructing a tree structure of the modeling files (60) of the sought design flow.

7. A computer program (70, 74, 80, 86) downloadable from a communication network and/or saved on a computer-readable medium and/or executable by a processor, characterized in that it comprises instructions for executing steps of a method for designing an integrated circuit as claimed in claim 1, when said program is executed on a computer.

8. A system for designing an integrated circuit with a plurality of layers interconnected together by sought three-dimensional connection devices (56), comprising:
means (70) for storing reference files (54) modeling a reference design flow including a predefined set (50, 52) of three-dimensional connection devices (30, 32, 34, 36, 38, 42, 44, 46) and reference design rules,
means (74; 80) for storing a design rule manual (58) relating to a sought design flow including sought three-dimensional connection devices (56),
a processor having access to the means for storing and generating modeling files (60) of the sought design flow using the reference files (54) and the design rule manual (58) provided,
characterized in that, the sought three-dimensional connection devices (56) all being selected from the three-dimensional connection devices (30, 32, 34, 36, 38, 42, 44, 46) of the reference design flow, the system comprises means (84) for filtering the reference files (54) by deleting any data relating to unselected three-dimensional connection devices and by specifying the reference design rules (50) using the design rule manual (58) provided, these filtering means being executable by the processor for generating modeling files (60) of the sought design flow,
and in that the system further comprises means, executable by the processor, for designing a model (62) of the integrated circuit using the modeling files (60) generated.

9. The system for designing an integrated circuit as claimed in claim 8, comprising an input interface (82), executable by the processor, for supplying, by a user, at least part of the design rules relating to the sought design flow including the sought three-dimensional connection devices (56), this input interface (82) comprising:
a field for selecting sought three-dimensional connection devices in the predefined set of three-dimensional connection devices (30, 32, 34, 36, 38, 42, 44, 46) of the reference design flow,
a field for inputting design rule values relating to the selected three-dimensional connection devices.

10. The system for designing integrated circuits as claimed in claim 9, wherein the input interface (82) is configured for inputting information from the design rule manual (58) relating to the sought design flow and completing same.
